(19) United States
(12) Patent Application Publication
(10) Pub. No.: US 2016/0293365 A1
(43) Pub. Date: Oct. 6, 2016

(54) RELAY SYSTEM

(71) Applicants: NIPPON SOKEN, INC., Nishio-city (JP); ANDEN CO., LTD., Anjo-city (JP)

(72) Inventors: Ken TANAKA, Nishio-city (JP); Shota IGUCHI, Kariya-city (JP)

(73) Assignees: NIPPON SOKEN, INC., Nishio-city (JP); ANDEN CO., LTD., Anjo-city (JP)

(21) Appl. No.: 15/086,297

(22) Filed: Mar. 31, 2016

(30) Foreign Application Priority Data
Mar. 31, 2015 (JP) 2015-072045

(51) Int. Cl. H01H 47/32

(52) U.S. Cl. CPC H01H 47/32

(57) ABSTRACT

A relay system includes a plurality of relays that is provided between a power supply unit supplying electric power and a load acting by receiving the electric power supplied from the power supply unit to switch between conduction and interruption of the electric power supplied from the power supply unit to the load, each of the relays having an exciting coil, a control unit that controls switching between application of current to the exciting coils and interruption of the current, first switches that separately excite the exciting coils, and a second switch that is connected between the exciting coils. The control unit controls turning on and off the first switches and the second switch to switch the exciting coils between parallel connection and series connection.

### CROSS-REFERENCE TO RELATED APPLICATION

This application is based on and claims the benefit of priority from earlier Japanese Patent Application No. 2015-72045 filed Mar. 31, 2015, the description of which is incorporated herein by reference.

### BACKGROUND

1. Technical Field

The present invention relates to a relay system having a plurality of relays and a control unit.

2. Related Art

An example of a technique is disclosed which relates to a ground fault interrupter that independently controls relay contacts for disconnecting a power line at the both ends thereof, so as to perform self-diagnoses of contact welding (for example, refer to JP-A-2012-152071). This ground fault interrupter detects a failure of a relay before supply of commercial power is started, and detects presence or absence of AC voltage for each phase of the power, to determine an abnormality of the relay. When determining an abnormality, the ground fault interrupter issues a warning on a display unit.

However, according to the technique of JP-A-2012-152071, the relay is provided to each phase of the power to perform switching operation. A solenoid (exciting coil) included in the relay is required to be supplied with the same current not only when attracting the plunger but also when holding the attraction state. Hence, a system to which the technique of JP-A-2012-152071 is applied has a problem that, as the attraction state is held longer, the power consumption increases.

### SUMMARY

An embodiment provides a relay system that reduces power consumption.

As an aspect of the embodiment, a relay system is provided which includes: a plurality of relays that is provided between a power supply unit supplying electric power and a load acting by receiving the electric power supplied from the power supply unit to switch between conduction and interruption of the electric power supplied from the power supply unit to the load, each of the relays having an exciting coil; a control unit that controls switching between application of current to the exciting coils and interruption of the current; first switches that separately excite the exciting coils; and a second switch that is connected between the exciting coils. The control unit controls turning on and off the first switches and the second switch to switch the exciting coils between parallel connection and series connection.

### BRIEF DESCRIPTION OF THE DRAWINGS

In the accompanying drawings:

FIG. 1 is a schematic view showing a first configuration example of a relay system;

FIG. 2 is a schematic view showing a first configuration example of a control unit;

FIG. 3 is a flowchart of a first procedure example of a connection switching control process;

FIG. 4 is a schematic view showing a second configuration example of the control unit;

FIG. 5 is a flowchart of a second procedure example of the connection switching control process;

FIG. 6 is a schematic view showing a second configuration example of the relay system;

FIG. 7 is a schematic view showing a third configuration example of the control unit;

FIG. 8 is a flowchart of a third procedure example of the connection switching control process;

FIG. 9 is a schematic view showing a fourth configuration example of the control unit;

FIG. 10 is a flowchart of a fourth procedure example of the connection switching control process;

FIG. 11 is a schematic view showing an example to which the relay system of the first configuration example is applied; and

FIG. 12 is a schematic view showing an example to which the relay system of the second configuration example is applied.

### DETAILED DESCRIPTION OF THE PREFERRED EMBODIMENTS

With reference to the accompanying drawings, hereinafter are described some embodiments according to the present invention. In the embodiments below, the wording “connection” means electrical connection unless otherwise stated. A capital letter and a small letter of the same alphabet character of reference numerals indicates different elements. For example, a control unit 11A and a controller 11a shown in FIG. 2 are different elements.

### First Embodiment

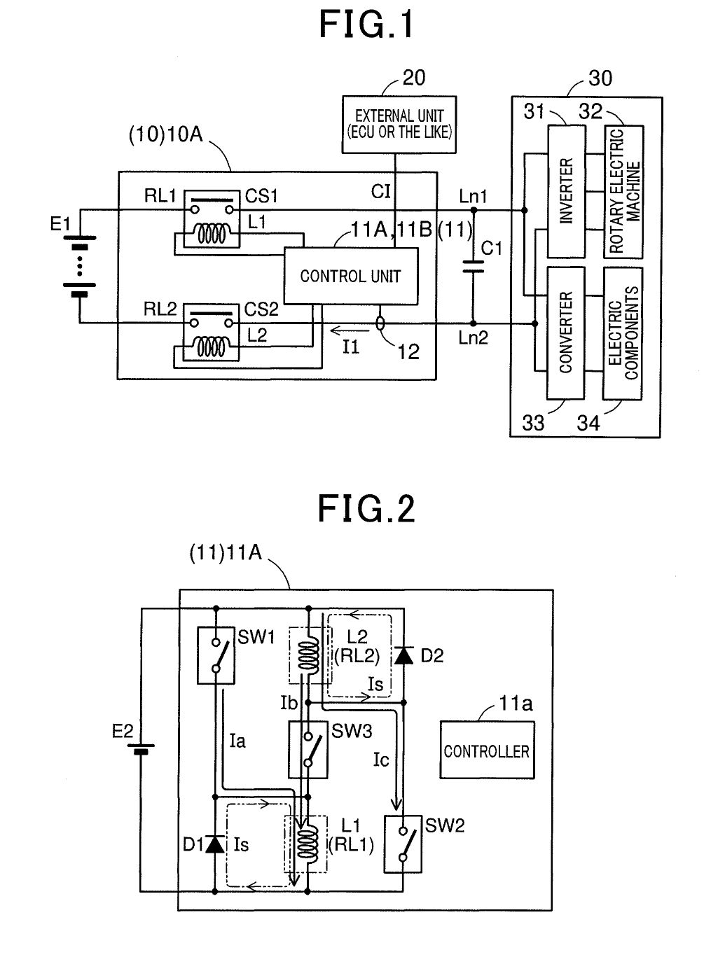

The first embodiment will be described with reference to FIGS. 1 to 3. A relay system 10A is an example of a relay system 10. The relay system 10A is provided between a power supply unit E1 and a load 30 and has a function of supplying electric power of the power supply unit E1 to the load 30 based on control information C1 transmitted from an external unit 20. The power supply unit E1 and the load 30 are connected by supply lines Ln1 and Ln2 so as to supply electric power. A smoothing capacitor C1, which smooths the electric power (specifically, voltage) supplied from the power supply unit E1, is connected between the supply line Ln1 and the supply line Ln2. The smoothing capacitor C1 may be provided between the relay system 10A and the load 30 as shown or at the output side of the relay system 10A (load 30 side).

The power supply unit E1 includes a secondary battery (e.g. lithium ion battery). The load 30 includes an inverter 31, a rotary electric machine 32, a converter 33, and electric components 34. The inverter 31 and the converter 33 are connected at the output side of the relay system 10A in parallel. At least one of the inverter 31 and the converter 33 may be configured so as to transmit signals to or receive signals from the external unit 20. The inverter 31 converts the electric power supplied from the power supply unit E1 and outputs the converted electric power to the rotary electric machine 32. The rotary electric machine 32 is a motor generator having functions of a motor and a generator. The converter 33 converts the electric power supplied from the power supply unit E1 and outputs the converted electric power to the electric components 34. The electric components 34 include electric equipment mounted to a vehicle, such as a measuring instrument, a car navigation system, lamps (e.g. headlights, interior lights, and taillights), air-conditioning equipment (an air conditioner, a heater, and the like), and motors for actuating wipers.

The relay system 10A of the configuration example shown in FIG. 1 has a plurality of relays RL1 and RL2, a control unit 11A, a current sensor 12, and the like. The relay RL1 has a contact CS1, an exciting coil L1, and the like. The relay RL2 has a contact CS2, an exciting coil L2, and the like. One side of the contact CS1 is connected to one pole (positive pole) side of the power supply unit E1 via the supply line Ln1, and the other side of the contact CS1 is connected to one pole side of the load 30 via the supply line Ln1. One side of the contact CS2 is connected to the other pole (negative pole) side of the power supply unit E1 via the supply line Ln2, and the other side of the contact CS2 is connected to the other pole side of the load 30 via the supply line Ln2. Each of the contacts CS1 and CS2 includes a plunger and a core (not shown). The exciting coils L1 and L2 are connected to the control unit 11A. Excitation/non-excitation states of the exciting coils L1 and L2 are separately controlled.

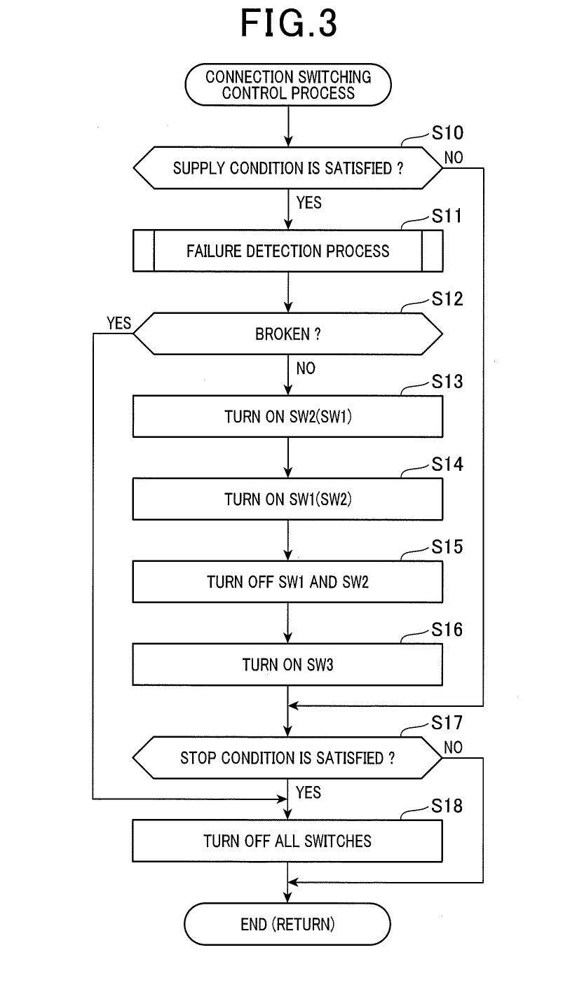

The control unit 11A is an example of the control unit 11. The control unit 11A includes a plurality of switches, and controls switching between parallel connection and series connection of the exciting coils L1 and L2. A specific configuration example and a control example of the control unit 11A are described later (refer to FIG. 2 and FIG. 3). The current sensor 12 detects a current I1 flowing through the supply lines Ln1 and Ln2.

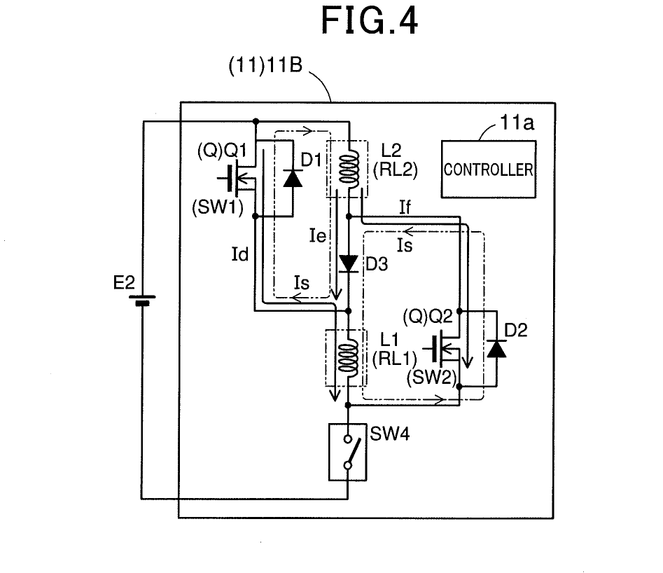

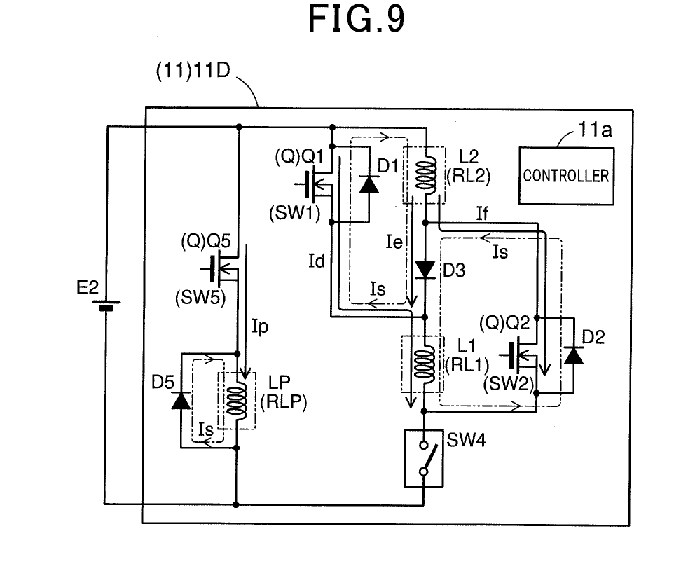

The control unit 11A shown in FIG. 2 includes first switches SW1 and SW2, a second switch SW3, rectifiers D1 and D2, and a controller 11a. Note that, in FIG. 2, the exciting coils L1 and L2 included in the relays RL1 and RL2 are enclosed by alternate long and two short dashes lines to make the connection state (parallel connection or series connection) of the exciting coils L1 and L2 understandable. Similarly, in FIG. 4, FIG. 7, and FIG. 9 described later, the exciting coils L1 and L2 are enclosed by alternate long and two short dashes lines.

Each of the first switches SW1 and SW2 and the second switch SW3 may be any element or component in which on (conduction)/off (non-conduction) can be controlled based on a signal transmitted from the controller 11a. For example, each of the first switches SW1 and SW2 and the second switch SW3 may be a contact switch, a transistor, or a semiconductor relay. Each of the rectifiers D1 and D2 may be an element having rectifying action, for example, a diode, a thyristor, or a MOSFET. In the present embodiment, diodes are used as the rectifiers D1 and D2.

The first switch SW1 and the rectifier D1 are connected in series (first series connection part). The exciting coil L2, the second switch SW3, and the exciting coil L1 are connected in series (second series connection part). The rectifier D2 and the first switch SW2 are connected in series (third series connection part). The first series connection part, the second series connection part, and the third series connection part are connected in parallel and are connected to the power supply unit E2. The power supply unit E2 is provided separately from the power supply unit E1 shown in FIG. 1, and supplies electric power (specifically, voltage) lower than that of the power supply unit E1.

A point between the first switch SW1 and the rectifier D1 is connected to a point between the second switch SW3 and the exciting coil L1. A point between the exciting coil L2 and the second switch SW3 is connected to a point between the rectifier D2 and the first switch SW2.

The controller 11a may be arbitrarily configured so as to control on (conduction)/off (non-conduction) of the first switches SW1 and SW2 and the second switch SW3. Part of or all of the controller 11a may be realized by software or hardware. For example, the part of or all of the controller 11a corresponds to a CPU (including a single chip CPU), a control circuit, or the like.

FIG. 3 illustrates an example of a connection switching control process performed by the controller 11a. This connection switching control process is repeatedly performed every time when the controller 11a operates. Note that steps S11 and S12 may be performed as necessary. Steps S13 to S16 correspond to first switching means (section).

First, the controller 11a determines whether or not a supply condition (start condition) is satisfied which is for starting supply of electric power to the load 30 (step S10). The supply condition may be arbitrarily set. In the example shown in FIG. 1, the supply condition includes a case where the rotary electric machine 32 is rotated when, for example, the vehicle runs, and a case where the electric components 34 such as electric equipment of the vehicle is operated. If the supply condition is not satisfied or if electric power is already supplied (NO), the process proceeds to step S17 described later.

In contrast, if the supply condition is satisfied (YES), the controller 11a performs a failure detection process for checks whether or not the relays RL1 and RL2 (specifically, the contacts CS1 and CS2) have broken (are defective) (step S11). In this failure detection process, turning on (conduction) only the first switch SW1 excites only the exciting coil L1, and turning on the contact CS1 conducts electricity to the supply line Ln1. If the current I1 flows to the supply line Ln2 (I1>0), the controller 11a determines that the relay RL2 has broken. In addition, turning on (conduction) only the first switch SW2 sets only the exciting coil L2 in an excitation state, and turning on the contact CS2 conducts electricity to the supply line Ln2. If the current I1 flows to the supply line Ln2 (I1>0), the controller 11a determines that the relays RL1 has broken. Furthermore, turning off (non-conduction) both the first switches SW1 and SW2 sets both the exciting coils L1 and L2 in non-excitation states. If the current I1 flows to the supply line Ln2 (I1>0), the controller 11a determines that both the relays RI1 and RL2 have broken.

If the controller 11a determines that at least one of the relays RL1 and RL2 is broken (YES in step S12), the controller 11a turns off all the switches of the relay system 10A (step S18), and the connection switching control process (including the return) is ended. In this case, the relays RL1 and RL2 are repaired and changed.

If the controller 11a determines that both the relays RL1 and RL2 are normal (NO in step S12), the controller 11a turns on (conduction) the first switch SW2 to excite the exciting coil L2 (step S13), and turns on (conduction) the first switch SW1 to excite the exciting coil L1 (step S14). In this case, as shown in FIG. 2, the exciting coils L1 and L2 are connected in parallel. When currents Ia and Ic (e.g. 500 [mA]) flow, the exciting coils L1 and L2 are respectively excited. Note that the timings when the first switches SW1 and SW2 are turned on may be the same or not (random order). In addition, since the contacts CS1 and CS2 are also turned on (conduction) while both the exciting coils L1 and L2 are excited, electric power is supplied to the load 30.

Then, to change the exciting coils L1 and L2 from the parallel connection to the series connection, after turning off (non-conduction) both the first switches SW1 and SW2 (step S15), the controller 11a turns on (conduction) the second switch SW3 (step S16). While the excitation of the exciting coils L1 and L2 is held, Step S16 is performed to avoid the re-attraction of the plungers included in the contacts CS1 and CS2. That is, step S16 is performed, while a surge current Is temporarily circulates (alternate long and two short dashes lines shown in FIG. 2), when the first switches SW1 and SW2 turn off, to flow through the exciting coils L1 and L2, and the contacts CS1 and CS2 are held on states.

A current Ib (e.g. 250 [mA]) flows to the exciting coils L1 and L2, which are changed to the series connection, thereby continuously supplying electric power to the load 30. The currents Ia and Ic require magnetomotive force large enough to attract the contacts CS1 and CS2. In contrast, since the current Ib is merely required to hold the attraction state by smaller magnetomotive force, the currents Ia and Ic can be smaller. Thus, since the contacts CS and CS2 can be held by the current Ib smaller than the currents Ia and Ic, as the holding time becomes longer, the power consumption of whole the relay system 10A can be lower.

The controller 11a determines whether or not a stop condition for stopping the supply of the electric power to the load 30 is satisfied (step S10). The stop condition may arbitrarily be set. For example, the stop condition includes a case where the vehicle stops (including temporary stop) to stop the rotation of the rotary electric machine 32, and a case where the vehicle is parked to stop the operation of the electric components 34.

If the stop condition is satisfied (YES), the controller 11a turns off all the switches of the relay system 10A (step S18), and the connection switching control process is ended. That is, all of the first switches SW1 and SW2 and the second switch SW3 are turned off. In contrast, if the stop condition is not satisfied (NO in step S17), the connection switching control process is ended without any operation.

### Second Embodiment

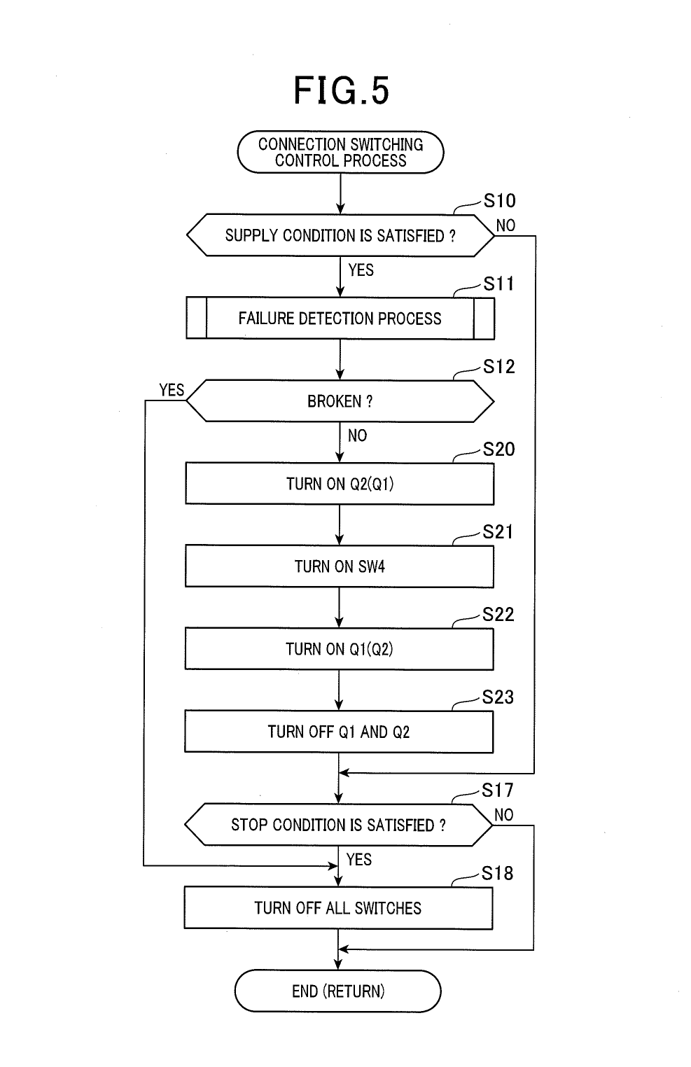

The second embodiment will be described with reference to FIG. 4 and FIG. 5. In the second embodiment below, the components identical with or similar to those of the first embodiment are given the same reference numerals for the sake of omitting unnecessary description. Hence, the differences from the first embodiment will be mainly described.

A control unit 11B shown in FIG. 4 is an example of the control unit 11 and is applied instead of the control unit 11A shown in FIG. 2. The control unit 11B includes transistors Q1 and Q2 a third switch SW4, a rectifier D3, and the controller 11a.

The transistors Q1 and Q2 are examples of the transistor Q. In the present embodiment, MOSFETs are applied. The transistor Q1 corresponds to the first switch SW1. The transistor Q2 corresponds to the first switch SW2. Each of the transistors Q1 and Q2 (MOSFETs) includes a parasitic diode serving as a reflux diode. The parasitic diodes are shown by the rectifiers D1 and D2 for the sake of convenience. Note that, regardless of presence or absence of the parasitic diode, at least one of the transistors Q1 and Q2 may be connected with a separate rectifier in parallel.

The exciting coil L2, the rectifier D3, the exciting coil L1, and the third switch SW4 are connected in series (fourth series connection part). The fourth series connection part is connected across the power supply unit E2. The transistor Q1 is connected between the positive electrode of the power supply unit E2, and a point between the rectifier D3 and the exciting coil L1. The transistor Q2 is connected between a point between the exciting coil L2 and the rectifier D3, and a point between the exciting coil L1 and the third switch SW4. The controller 11a controls turning on and off the transistors Q1 and Q2, the third switch SW4, and the like.

FIG. 5 illustrates an example of the connection switching control process performed by the controller 11a. The connection switching control process illustrated in FIG. 5 is repeatedly performed every time when the controller 11a operates, instead of the connection switching control process shown in FIG. 3. FIG. 5 differs from FIG. 3 in that steps S20 to S23 are performed instead of S13 to S16. Steps S20 to S23 correspond to a first switching section (means).

In the failure detection process in step S11, the controller 11a checks whether or not the relays RL1 and RL2 have been broken. Specifically, in step S11 shown in FIG. 3, the switches SW1 and SW2 may be replaced by the transistors Q1 and Q2.

If the controller 11a determines that both the relays RL1 and RL2 are normal (NO in step S12), the controller 11a turns on (conduction) the transistor Q to excite the exciting coil L2 (step S20), and turns on (conduction) the third switch SW4 (step S21). The third switch SW4 may be turned on simultaneously with turning on the transistor Q2 or after turning on the transistor Q2. After the third switch SW4 is turned on, a current If flows to the exciting coil L2 to excite the exciting coil L2.

After the third switch SW4 is turned on, the transistor Q1 is turned on (conduction). Thereby, a current Id flows to the exciting coil L1 to excite the exciting coil L1 (step S22). In this time, since the voltage applied across the rectifier D3 is lower than the forward voltage drop, the current Id and a current Ie flown in parallel as shown in FIG. 4. Hence, the exciting coils L1 and L2 become a parallel connection state. Note that since the contacts CS1 and CS2 also turn on (conduction) while both the exciting coils L1 and L2 are excited, electric power is supplied to the load 30.

Note that the timings of turning on the transistors Q1 and Q2 are not limited to the order described above. As indicated by brackets in steps S20 to S22, the transistor Q2 may be turned on, after the transistor Q1 is turned on and next the third switch SW4 is turned on.

Then, to change the exciting coils L1 and L2 from the parallel connection to the series connection, the transistors Q1 and Q2 are simultaneously turned off (non-conduction) (step S23). In this time, the current Ie flows through the fourth series connection part (the exciting coil L2, the rectifier D3, the exciting coil L1, and the third switch SW4) to hold the excitation of the exciting coils L1 and L2. In parallel with this excitation, a surge current Is (shown by alternate long and two short dashes lines) temporarily circulates through the rectifiers D1, D2, and D3 and then disappears. Since the excitation of the exciting coils L1 and L2 is held, the on states (conduction) of the contacts CS1 and CS2 are also held, and electric current is continuously supplied to the load 30.

Thereafter, if the stop condition is satisfied (YES in step S17), the controller 11a turns off all the switches of the relay system 10A (step S18), and connection switching control process is ended. That is, the controller 11a turns off all of the transistors Q1 and Q2 and the third switch SW4. In contrast, if the stop condition is not satisfied (NO in step S17), the connection switching control process is ended without any operation.

According to the above control unit 11B, since the transistors Q1 and Q2 (MOSFETs) including parasitic diodes (D1, D2) functioning as reflux diodes are used, separate reflux diodes (rectifiers) are not required. Hence, the manufacturing cost can be reduced by those of the unneeded reflux diodes. Since the number of components required for the configuration of the relay system 10A decreases, the relay system 10A can be decreased in size. Furthermore, the control unit 11B includes the rectifier D3 (refer to FIG. 4). Hence, when the exciting coils L1 and L2 are changed from the parallel connection to the series connection, the transistors Q1 and Q2 are merely turned off simultaneously. Thereby, the contacts CS1 and CS2 are prevented from being turned off.

### Third Embodiment

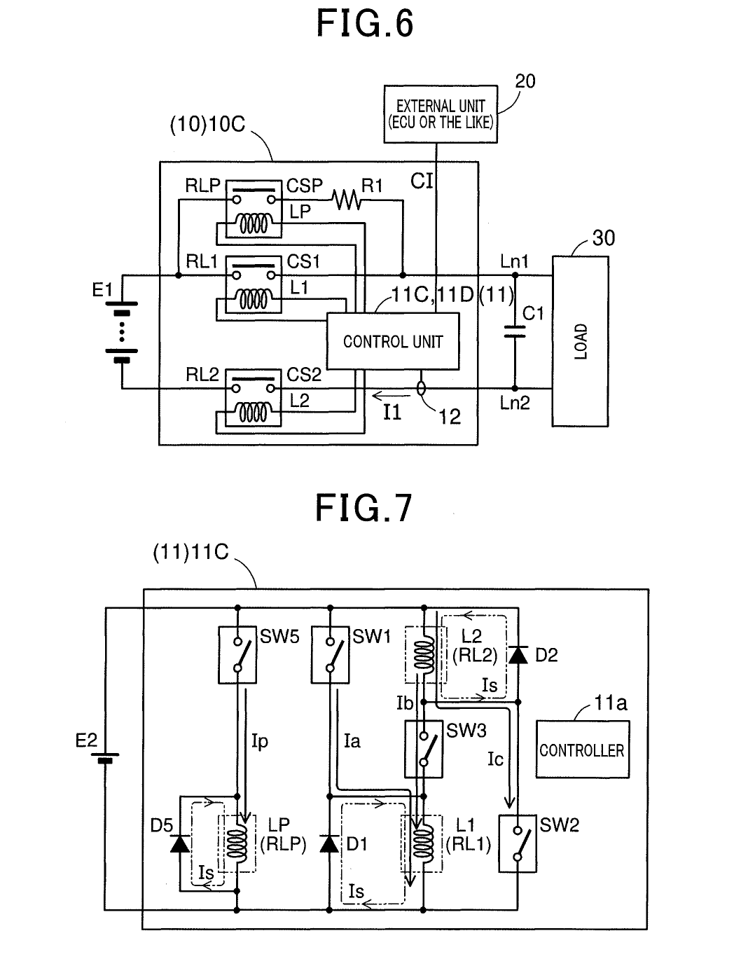

The third embodiment is a modification of the first embodiment and will be described with reference to FIG. 6 to FIG. 8. In the third embodiment below, the components identical with or similar to those of the first embodiment are given the same reference numerals for the sake of omitting unnecessary description. Hence, the differences from the first embodiment will be mainly described.

A relay system 10C shown in FIG. 6 is an example of the relay system 10. The relay system 10C is provided between the power supply unit E1 and the load 30 and has a function of supplying electric power of the power supply unit E1 to the load 30 based on the control information C1 transmitted from an external unit 20.

The relay system 10C has a plurality of relays RL1, RL2, and RLP, a current-limiting resistor R1, a control unit 11C, a current sensor 12, and the like. The relay RLP and the current-limiting resistor R1 are connected to each other in series and are connected to the relay RL1 in parallel. The relay RLP has a contact CSP, an exciting coil LP, and the like. The exciting coil LP is connected to the control unit 11C together with the exciting coils L1 and L2. Excitation/non-excitation states of the exciting coil LP and the exciting coils L1 and L2 are separately controlled.

The control unit 11C shown in FIG. 7 is an example of the control unit 11. The control unit 11C includes a plurality of switches, and controls switching between the parallel connection and the series connection of the exciting coils L1 and L2. The control unit 11 has the first switches SW1 and SW2, the second switch SW3, the fourth switch SW5, the rectifiers D1, D2, and D5, the controller 11a, and the like.

The fourth switch SW5 and the exciting coil LP are connected in series (fifth series connection part). The fifth series connection part is connected to the first series connection part, the second series connection part, and the third series connection part in parallel, and is connected to the power supply unit E2. The rectifier D5 is connected to the exciting coil LP in parallel.

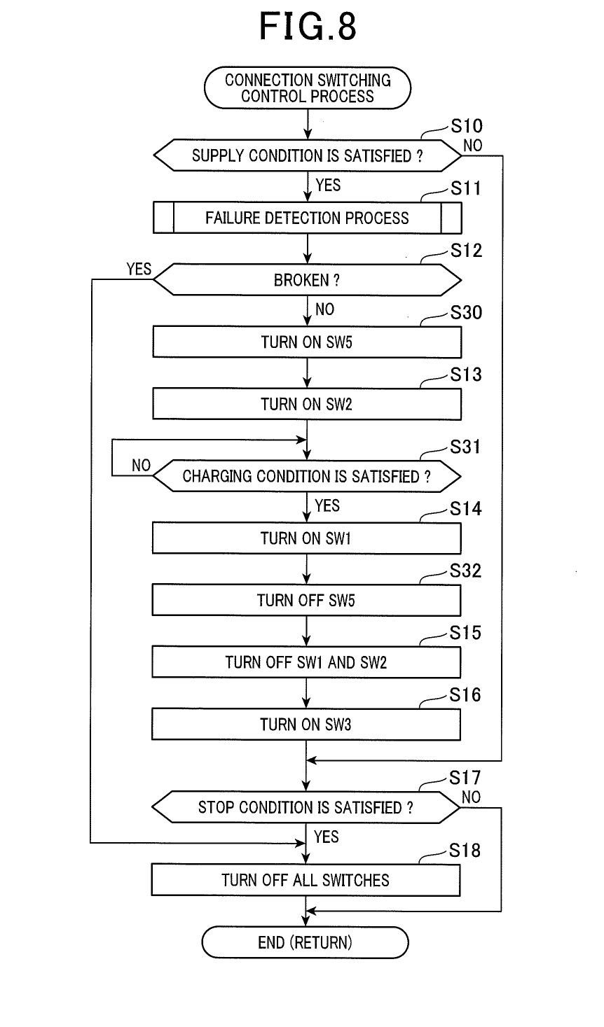

FIG. 8 illustrates an example of the connection switching control process performed by the controller 11a. The connection switching control process illustrated in FIG. 8 is repeatedly performed every time when the controller 11a operates, instead of the connection switching control process illustrated in FIG. 3. FIG. 8 differs from FIG. 3 in that steps S30 to S33 are added.

If the controller 11a determines that both the relays RL1 and RL2 are normal (NO in step S12), the controller 11a turns on (conduction) the fourth switch SW5 to make a current Ip flow to excite the exciting coil LP (step S30). When the exciting coil LP is excited, the contact CSP is turned on (conduction). Hence, a current flows from the power supply unit E1 and through the current-limiting resistor R1. Then, the smoothing capacitor C1 is charged. Hence, the smoothing capacitor C1 can be pre-charged.

After the first switch SW2 is turned on (conduction) (step S13), pre-charging the smoothing capacitor C1 is repeated until a charging condition is satisfied (NO in step S31). The charging condition may be arbitrarily set. For example, the charging condition includes the fact that a predetermined time period has passed from the time when the fourth switch SW5 is turned on, the fact that the voltage of the smoothing capacitor C1 has reached a predetermined voltage, and the fact that the current flowing through the current-limiting resistor R1 has reached a predetermined current. Any of the predetermined time period, the predetermined voltage, and the predetermined current may be arbitrarily set if they are the conditions for stopping charging the smoothing capacitor C1.

If the charging condition is satisfied (YES in step S31), the parallel connection and the series connection of the exciting coils L1 and L2 are switched therebetween as in the case of steps S14 to S16 shown in FIG. 3. Note that after the first switch SW1 is turned on (conduction) (step S14), the fourth switch SW5 is turned off (non-conduction) before the first switches SW1 and SW2 are turned off (non-conduction) (step S15), to set the exciting coil LP in a non-excitation state (step S32). When the exciting coil LP becomes a non-excitation state, the contact CSP is turned off (non-conduction). Hence, pre-charging the smoothing capacitor C1 is stopped.

According to the configuration described above, pre-charging the smoothing capacitor C1 can be performed together with switching the exciting coils L1 and L2 between the parallel connection and the series connection. Since pre-charging the capacitor C1 can be performed, electric power can be stably supplied to the load 30.

### Fourth Embodiment

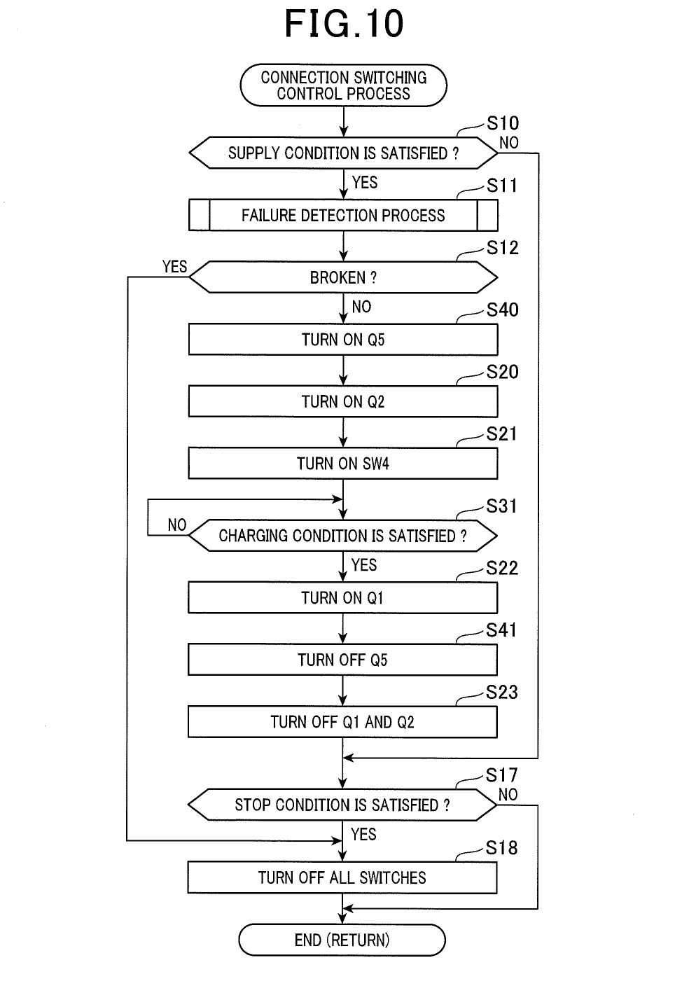

The fourth embodiment is a modification of the second embodiment and will be described with reference to FIG. 9 and FIG. 10. In the fourth embodiment below, the components identical with or similar to those of the second embodiment are given the same reference numerals for the sake of omitting unnecessary description. Hence, the differences from the second embodiment will be mainly described.

A control unit 11D shown in FIG. 9 is an example of the control unit 11 and is applied instead of the control unit 11C shown in FIG. 6. The control unit 11D has the transistors Q1, Q2, and Q5, the third switch SW4, the rectifier D3, the controller 11a, and the like.

The transistor Q5 is an example of the transistor Q, and corresponds to the fourth switch SW5. The transistor Q5 of the present embodiment is a MOSFET.

The transistor Q5 and the exciting coil LP are connected in series (sixth series connection part). The sixth series connection part is connected to the fourth series connection part (the exciting coil L2, the rectifier D3, the exciting coil L1, and the third switch SW4) in parallel, and is connected to the power supply unit E2.

FIG. 10 illustrates an example of the connection switching control process performed by the controller 11a. The connection switching control process illustrated in FIG. 10 is repeatedly performed every time when the controller 11a operates, instead of the connection switching control process illustrated in FIG. 5. FIG. 5 differs from FIG. 3 in that steps S31, S40, and S41 are added.

If the controller 11a determines that both the relays RL1 and RL2 are normal (NO in step S12), the controller 11a turns on (conduction) the transistor Q5 to make a current Ip flow to excite the exciting coil LP (step S40). When the exciting coil LP is excited, the contact CSP is turned on (conduction). Hence, a current flows from the power supply unit E1 and through the current-limiting resistor R1. Then, the smoothing capacitor C1 is charged. Hence, the smoothing capacitor C1 can be pre-charged.

After the third switch SW4 is turned (conduction) (step S21), the smoothing capacitor C1 is pre-charged until a charging condition is satisfied (NO in step S31).

After the transistor Q1 is turned on (conduction) (step S22), the transistor Q5 is turned off (non-conduction) before the transistors Q1 and Q2 are turned off (non-conduction) (step S23), to set the exciting coil LP in a non-excitation state (step S41). When the exciting coil LP becomes a non-excitation state, the contact CSP is turned off (non-conduction). Hence, pre-charging the smoothing capacitor C1 is stopped.

According to the configuration described above, pre-charging the smoothing capacitor C1 can be performed together with switching the exciting coils L1 and L2 between the parallel connection and the series connection. Since pre-charging the smoothing capacitor C1 can be performed, electric power can be stably supplied to the load 30.

### Other Embodiments

It will be appreciated that the present invention is not limited to the configurations described above, but any and all modifications, variations or equivalents, which may occur to those who are skilled in the art, should be considered to fall within the scope of the present invention.

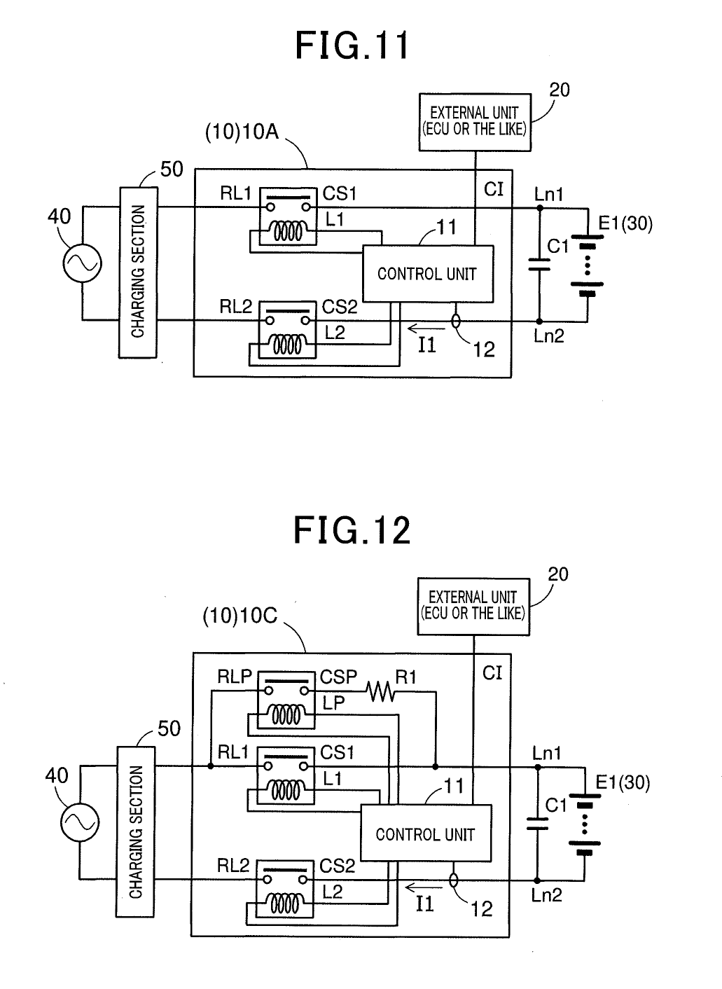

In the above first to fourth embodiments, electric power of the power supply unit E1 is supplied to the load 30 (refer to FIG. 1 and FIG. 6). That is, electric power discharged from the power supply unit E1 is used. Instead of the embodiments (or in addition to the embodiments), as shown in FIG. 11 and FIG. 12, it may be configured so that a commercial power supply 40 serves as a power supply unit, the power supply unit E1 serves as the load 30, to supply electric power provided from the commercial power supply 40 to the power supply unit E1. That is, the power supply unit E1 is charged. A charging section 50, which controls charging the power supply unit E1, is provided between the commercial power supply 40 and the relay system 10. Even when the power supply unit E1 serves as the load 30, the exciting coils L1 and L2 are switched between the parallel connection and the series connection when electric power is supplied. Hence, the power consumption of whole the relay system 10 can be reduced compared with the conventional systems.

In the above second and fourth embodiments, the transistors Q1 and Q2 of the MOSFETs, in which a parasitic diode is formed, are used as the first switches SW1 and SW2 (refer to FIG. 4 and FIG. 9). Instead of the embodiments, MOSFETs in which a parasitic diode is not formed, bipolar transistors (including power transistors), FETs or IGBTs other than the MOSFETs, or the like may be used. Except for the necessity of the separate rectifiers D1 and D2, the advantages similar to those of the second and fourth embodiments can be provided.

In the above second and fourth embodiments, the transistor Q1 is used for the first switch SW1, and the transistor Q2 is used for the first switch SW2 (refer to FIG. 4 and FIG. 9). Instead of the embodiments, the transistor Q1 may be used for the first switch SW1, and a contact switch, a semiconductor relay, or the like may be used for the first switch SW2. In addition, the transistor Q2 may be used for the first switch SW2, and a contact switch, a semiconductor relay, or the like may be used for the first switch SW1. Even when elements or components other than the transistor are used, the advantages similar to those of the second and fourth embodiments can be provided.

In the above first to fourth embodiments, positive logic is used in which application of current or conduction corresponds to an on state, and interruption of current or non-conduction corresponds to an off state (refer to FIG. 3, FIG. 5, FIG. 8, and FIG. 10). Instead of the embodiments, negative logic in which an on state and an off state are inverted may be used. That is, when a signal transmitted by the controller 11a is an off state, application of current or conduction is made. When the signal transmitted by the controller 11a is an on state, interruption or non-conduction is made. Since this is merely a difference between positive logic and negative logic, the advantages similar to those of the first to fourth embodiments can be provided.

In the above first to fourth embodiments, the first switching means (section) switches the plurality of exciting coils L1 and L2 from parallel connection to series connection (refer to steps S13 to S16 shown in FIG. 3 and FIG. 8, and refer to steps S20 to S23 shown in FIG. 5 and FIG. 10). Instead of the embodiments, a second switching means (section) may switch the plurality of exciting coils L1 and L2 from the series connection to the parallel connection. When the plurality of exciting coils L1 and L2 are switched to the series connection, the voltage applied to each of the exciting coils L1 and L2 is decreased. Hence, the attraction states of the contacts CS1 and CS2 may not be held depending on the electric power (especially, voltage) supplied from the power supply unit E1. Thus, a sensor (e.g. voltage sensor, current sensor, or electric power sensor) detecting electric power (including voltage and current) supplied from the power supply unit E1 and the control unit 11 may be included. The control unit 11 switches the plurality of exciting coils L1 and L2 to the parallel connection again if the detection value of the sensor is lower than a threshold value. The threshold value may be arbitrarily set depending on the relay RL1, RL2, RLP, and the like. Switching from the series connection to the parallel connection may be in the inverse order of switching from the parallel connection to the series connection. According to this configuration, the attraction states of the contacts CS1 and CS2 can be reliably held. If the electric power supplied from the power supply unit E1 is equal to or more than a threshold value, the power consumption can be reduced compared with the conventional systems.

According to the first to fourth embodiments, the relay system 10 (10A, 10C) includes two relays RL1 and RL2 (refer to FIG. 1 and FIG. 6). Alternatively, three or more relays may be included. Since this configuration merely has a different number of relays, the advantages similar to those of the first to fourth embodiments can be provided.

### (Advantages)

According to the above first to fourth embodiments and other embodiments, the following advantages can be provided.

(1) The relay system 10 (10A, 10C) has the first switches SW1 and SW2 for separately exciting the plurality of exciting coils L1 and L2, and the second switch SW3 connected between the exciting coils L1 and L2. The control unit 11 (11A to 11D) controls turning on and off the first switches SW1 and SW2 and the second switch SW3 to switch the plurality of exciting coils L1 and L2 between the parallel connection and the series connection (refer to FIG. 1, FIG. 2, FIG. 4, FIG. 6, FIG. 7, FIG. 9, FIG. 11, and FIG. 12). According to this configuration, when the plungers included in the contacts CS1 and CS2 are attracted, the plurality of relays RL1 and RL2 are connected in parallel to ensure magnetomotive force required for the attraction. When the attraction states of the plungers are held, the plurality of exciting coils L1 and L2 are connected in series to ensure magnetomotive force required for the holding. When the attraction states are held, current is required which is smaller than that required when the plungers are attracted. Hence, the power consumption can be reduced compared with the conventional systems. For example, if resistance values of the exciting coils L1 and L2 included in the relays RL1 and RL2 are the same, the current flowing when the series connection is made is a quarter of the current flowing when the parallel connection is made. Hence, after the plurality of exciting coils L1 and L2 are connected in series, the power consumption can be reduced by 75%.

(2) The control unit 11 (specifically, the controller 11a) includes at least one of the first switching means (section) that switches the plurality of exciting coils L1 and L2 from the parallel connection to the series connection and the second switching means (section) that switches the plurality of exciting coils L1 and L2 from the series connection to the parallel connection (refer to FIG. 3, FIG. 5, FIG. 8, and FIG. 10). According to this configuration, in both cases of the first switching means and the second switching means, a process of making the parallel connection of the plurality of exciting coils L1 and L2 is included. Hence, the power consumption of whole the relay system can be reduced compared with the conventional systems.

(3) The reflux diodes (rectifiers D1 and D2) are connected to the exciting coils L1 and L2 in parallel to circulate the surge current generated when application of current to the exciting coils L1 and L2 is interrupted (refer to FIG. 2, FIG. 4, FIG. 7, and FIG. 9). According to this configuration, even if current to the exciting coils L1 and L2 is interrupted when the plurality of exciting coils L1 and L2 are switched between the parallel connection and the series connection, the surge current Is circulates through the rectifiers D1 and D2. Hence, damage to the electric components due to the surge current Is can be prevented.

(4) At least one of the first switches SW1 and SW2 and the second switch SW3 are the transistors Q1 and Q2, which can control conduction and non-conduction (refer to FIG. 4 and FIG. 9). According to this configuration, the transistors Q1 and Q2 are used for the first switches SW1 and SW2 and the second switch SW3. Since the transistors Q1 and Q2 can easily control conduction and non-conduction, switching between the parallel connection and the series connection of the exciting coils L1 and L2 can be easily performed for the plurality of relays L1 and L2.

(5) The transistors Q1 and Q2 include the parasitic diodes (D1, D2) serving as reflux diodes (refer to FIG. 4 and FIG. 9). According to this configuration, since separate rectifiers are not required, the manufacturing cost can be reduced by those of the unneeded reflux diodes. In addition, since the number of components required for the configuration of the relay system 10 decreases, the relay system 10 can be decreased in size.

(6) The second switch SW3 is the rectifier D3 (refer to FIG. 4 and FIG. 9). According to this configuration, the number of the switches required for the relay system 10 can be decreased. The manufacturing cost can be reduced by those of the unneeded switches. In addition, since the number of components required for the configuration of the relay system 10 decreases, the relay system 10 can be decreased in size. Furthermore, when the exciting coils L1 and L2 are switched from the parallel connection to the series connection, the transistors Q1 and Q2 are merely turned off simultaneously. Thereby, the contacts CS1 and CS2 can be prevented from being tuned off. That is, the re-attraction of the plungers included in the contacts CS1 and CS2 is prevented to lower the power consumption.

(7) The control unit 11 (specifically, the controller 11a) turns on the first switches SW1 and SW2 to connect the plurality of exciting coils L1 and L2 in parallel, and turns off the first switches SW1 and SW2 to switch the coils L1 and L2 to the series connection (refer to FIG. 4 and FIG. 9). According to this configuration, merely controlling turning on and off the first switches SW1 and SW2 can simply switch the plurality of exciting coils L1 and L2 between the parallel connection and the series connection.

(8) The third switch SW4 is provided which is connected with the plurality of exciting coils L1 and L2 in series. The control unit 11 turns on the third switch SW4 to switch the plurality of exciting coils L1 and L2 between the parallel connection and the series connection to set them in excitation states, and turns off the third switch SW4 to set them in non-excitation states (refer to FIG. 4 and FIG. 9). According to this configuration, switching the exciting coils L1 and L2 between the parallel connection and the series connection is performed only when the third switch SW4 is an on state. If the third switch SW4 is turned off, the plurality of exciting coils L1 and L2 can be reliably made non-excitation states.

(9) The current sensor 12 detecting a current flowing from the power supply unit E1 to the load 30 and the fourth switch SW5 connected with the exciting coils L1 and L2 in series are provided. The control unit 11 turns on the fourth switch SW5 and a predetermined first switch (the first switch SW1 or the first switch SW2), and detects a failure of the plurality of exciting coils L1 and L2 based on the current detected by the current sensor 12 (refer to FIG. 4 and FIG. 9). According to this configuration, a failure of the exciting coils L1 and L2 can be reliably detected.

(10) A sensor detecting electric power (voltage or current) supplied from the power supply unit E1 is provided. If the detection value of the sensor is equal to or more than a threshold value, the control unit 11 (specifically, the controller 11a) switches the plurality of exciting coils L1 and L2 from parallel connection to series connection (makes the exciting coils L1 and L2 the parallel connection, and then switches the exciting coils L1 and L2 from the parallel connection to the series connection) by the first switching means. If the detection value of the sensor is less than the threshold value, the control unit 11 switches the exciting coils L1 and L2 from the series connection to the parallel connection (makes the exciting coils L1 and L2 the series connection, and then switches the exciting coils L1 and L2 from the series connection to the parallel connection) by the second switching means (refer to FIG. 3, FIG. 5, FIG. 8, and FIG. 10). According to this configuration, the attraction states of the contacts CS1 and CS2 can be reliably held. When the electric power supplied from the power supply unit E1 is equal to or more than the threshold value, the power consumption can be lowered compared with the conventional systems. In addition, the attraction states of the contacts CS1 and CS2 can be reliably held.

Hereinafter, aspects of the above-described embodiments will be summarized.

As an aspect of the embodiment, a relay system (10) is provided which includes: a plurality of relays (RL1, RL2) that is provided between a power supply unit (E1) supplying electric power and a load (30) acting by receiving the electric power supplied from the power supply unit to switch between conduction and interruption of the electric power supplied from the power supply unit to the load, each of the relays having an exciting coil (L1, L2); a control unit (11) that controls switching between applying current to the exciting coils and interruption of applying the current; first switches (SW1, SW2) that separately excite the exciting coils; and a second switch (SW3) that is connected between the exciting coils. The control unit controls turning on and off the first switches and the second switch to switch the exciting coils between parallel connection and series connection.

The contact of the relay has a plunger, a core around which the exciting coil is wound, and the like. Since an air gap is provided between the plunger and the core, magnetic resistance of the magnetic circuit is higher, which makes a magnetic flux difficult to flow. Although larger magnetomotive force (a current flowing to the exciting coil) is required when the plunger is attracted, the magnetic resistance of the magnetic circuit is smaller, which makes a magnetic flux easily flow. Hence, when the plunger attracted to the core is held, only smaller magnetomotive force is required.

According to this configuration, when electric power is supplied from the power supply unit to the load, the control unit switches the plurality of relays between the parallel connection and the series connection. When the plungers are attracted, the plurality of relays are connected in parallel to ensure magnetomotive force required for the attraction. When the attraction states of the plungers are held, the plurality of relays are connected in series to ensure magnetomotive force required for the holding. When the attraction states are held, current is required which is smaller than that required when the plungers are attracted. Hence, the power consumption can be reduced compared with the conventional systems. For example, if resistance values of the exciting coils included in the relays are the same, the current flowing when the series connection is made is a quarter of the current flowing when the parallel connection is made. Hence, after the series connection is made, the power consumption can be reduced by 75% compared with that given when the parallel connection is made.

As another aspect of the embodiment, at least one of the first switches and the second switch is a transistor (Q1, Q2) that controls conduction and non-conduction.

According to this configuration, at least one transistor is used for at least one of the first switches and the second switch. Since conduction and non-conduction of the transistor can be easily controlled, the plurality of relays can be easily switched between the parallel connection and the series connection.

As another aspect of the embodiment, the transistor includes a parasitic diode serving as the reflux diode.

According to this configuration, without separate reflux diodes, the surge current can be circulated by the parasitic diode included in the transistor. The manufacturing cost can be reduced by those of the unneeded reflux diodes. In addition, circuits, devices, and the like can be decreased in size.

Note that the power supply unit is arbitrarily configured on condition that the power supply unit can supply electric power. For example, the power supply unit includes a secondary battery that is capable of charge and discharge, and a power source (e.g. solar battery) that is capable of supplying electric power. The load is arbitrarily configured on condition that the load operates by receiving the supplied electric power. The load includes a rotary electric machine, electric components, and a power supply unit that is capable of charge and discharge. The rotary electric machine is arbitrary equipment having a rotating part (e.g. a shaft). The rotary electric machine is, for example, a generator, a motor, or a motor generator. The electric components are electric equipment mainly installed in a vehicle, but may be that installed in an object other than the vehicle. The relay is, unless otherwise stated, an electromagnetic relay that physically moves a contact depending on presence or absence of excitation to apply current and interrupt applying the current. The first switch, the second switch, the third switch, and the fourth switch are arbitrarily configured on condition that all the first to fourth switches can be controlled by the control unit so as to be turned on and off. Each of the first to fourth switches is, for example, a contact switch, a transistor, or a semiconductor relay (SSR: Solid State Relay). The transistor is an arbitrary semiconductor device which can be controlled so as to be turned on and off. For example, the transistor is a bipolar transistor (including a power transistor), an FET (field effect transistor), and an IGBT (Insulated gate bipolar transistor). The reflux diode is a rectifier, for example, a diode, a thyristor, or a MOSFET (metal-oxide semiconductor field-effect transistor), and includes a parasitic diode formed in a MOSFET or the like. The MOSFET includes a power MOSFET and CMOS.

What is claimed is:

1. A relay system, comprising:
a plurality of relays that is provided between a power supply unit supplying electric power and a load acting by receiving the electric power supplied from the power supply unit to switch between conduction and interruption of the electric power supplied from the power supply unit to the load, the relays having respective exciting coils;
a control unit that controls switching between application of current to the exciting coils and interruption of the current;
first switches that separately excite the exciting coils; and
a second switch that is connected between the exciting coils, wherein
the control unit controls turning on and off the first switches and the second switch to switch the exciting coils between parallel connection and series connection.

2. The relay system according to claim 1, wherein
the control unit has at least one of a first switching section that switches the exciting coils from the parallel connection to the series connection and a second switching section that switches the exciting coils from the series connection to the parallel connection.

3. The relay system according to claim 1, further comprising reflux diodes that are connected to the exciting coils in parallel to circulate a surge current generated when the application of the current to the exciting coils is interrupted.

4. The relay system according to claim 1, wherein
at least one of the first switches and the second switch is a transistor that controls conduction and non-conduction.

5. The relay system according to claim 4, wherein the transistor includes a parasitic diode serving as the reflux diode.

6. The relay system according to claim 1, wherein the second switch is a rectifier.

7. The relay system according to claim 6, wherein the control unit turns on the first switches to make the exciting coils the parallel connection, and turns off the first switches to switch the exciting coils to the series connection.

8. The relay system according to claim 6, further comprising a third switch that is connected to the exciting coils in series, wherein the control unit turns on the third switch to switch the exciting coils between parallel connection and series connection and sets the exciting coils in excitation states, and turns off the third switch to set the exciting coils in non-excitation states.

9. The relay system according to claim 1, further comprising:
a current sensor that detects a current flowing from the power supply unit to the load; and
a fourth switch that is connected to the exciting coil in series, wherein
the control unit turns on the fourth switch and one of the first switches to detect a failure of the relays based on the current detected by the current sensor.
